(19) United States
(12) Patent Application Publication
(10) Pub. No.: US 2026/0070288 A1
(43) Pub. Date: Mar. 12, 2026

(54) MANUFACTURING METHOD OF SPOKE ASSEMBLY

(71) Applicant: Xiamen Carbonking Composites Technology Co., Ltd., Xiamen (CN)

(72) Inventors: Wurui Liu, Xiamen (CN); Peilong Xiao, Xiamen (CN)

(21) Appl. No.: 19/220,896

(22) Filed: May 28, 2025

(30) Foreign Application Priority Data
Jun. 28, 2024 (CN) 202410866399.5

(51) Int. Cl. B29C 70/02; B29K 307/04; B29L 31/30

(52) U.S. Cl. CPC B29C 70/023; B29K 2307/04; B29L 2031/3091

(57) ABSTRACT

The present invention discloses a manufacturing method of a spoke assembly, including the following steps: S1: providing a preform made of cylindrical carbon fiber; S2: providing a first connector and a second connector; S3: enabling both the first connector and the second connector to sleeve a middle portion of the preform; S4: wrapping consecutive carbon fiber layers around two ends of the preform to form conical pillar sections; S5: curing the conical pillar sections of the preform at one time to form fixed joints; S6: applying pulling forces toward end sides to the first connector and the second connector, so as to respectively sleeve the fixed joints at two ends of the preform, such that the preform is processed into a spoke, and the spoke is less prone to delamination or slippage.

### CROSS-REFERENCE TO RELATED APPLICATIONS

This application claims priority to Chinese Patent Application 202410866399.5, filed on Jun. 28, 2024, which is incorporated herein by reference.

### TECHNICAL FIELD

The present invention relates to the technical field of carbon fiber spoke manufacturing, specifically to a manufacturing method of a spoke assembly.

### BACKGROUND

The spoke assembly is mainly applied to the bicycle rim. The spoke assembly includes a spoke 1′and a nut cap and a cap head respectively installed at the two ends of the spoke 1′. As shown in FIGS. 8 and 9, the current structure of the spoke 1′includes a flat main body 11′located in the middle and cylindrical end portions located at both ends. An inner side section of the end portion is a cylindrical transition section 12′, and an outer side section is processed to form a fixed joint 13′. The nut cap and the cap head respectively fixedly sleeve the fixed joints 13′at the two end portions, while the cylindrical transition section 12′is exposed on the cap head or outside the cap head.

The current manufacturing process of the spoke assembly is as follows: First, a preform made of cylindrical carbon fiber is heated and cured, such that a middle portion of the preform is heated and cured to form the flat main body 11′. Two ends of the preform are also cured to form cylindrical structures, the cylindrical structure including the cylindrical transition section 12′on a side closer to the middle of the spoke 1′and a fixed section on a side farther from the middle of the spoke 1′. Then, the cap head and the nut cap are respectively inserted onto the cylindrical transition sections 12′of the cylindrical structures at both ends of the spoke 1′. Subsequently, the fixed section is wrapped with a carbon fiber layer and heated to form the fixed joint 13′. The nut cap and the cap head are pulled outward toward the ends of the spoke 1′, and through the limiting action of the fixed joints 13′, the nut cap and the cap head respectively fixedly sleeve the fixed joints 13′at both ends of the spoke 1′.

The spoke assembly manufactured by the above method has the following shortcomings:
(1) The inner and outer carbon fiber layers wrapped sequentially at the position of the fixed joint 13′of the spoke 1′are heated and cured in two separate steps. Specifically, an inner layer 131′(that is, the cylindrical structure) and an outer layer 132′of the fixed joint are heated and cured sequentially, resulting in discontinuous or broken fiber distribution between the inner and outer carbon fiber layers of the fixed joint 13′. This makes it prone to delamination or slippage, posing certain safety hazards.
(2) Since the width of the main body 11′is greater than the diameter of the end portions, if the main body 11′is processed and formed first, a long length must be reserved for the cylindrical transition section 12′of the end portion to achieve temporary sleeving of the nut cap or the cap head. Only after the fixed section at the end portion is wrapped with the carbon fiber layer and cured to form the fixed joint 13′can the nut cap or cap head be withdrawn from the cylindrical transition section 12′and fixed outside the fixed joint 13′. This manufacturing method results in a long cylindrical transition section 12′, and correspondingly, a relatively short main body 11′. Specifically, the length of the main body 11′accounts for a small proportion of the overall length of the spoke 1′, which leads to large wind resistance during cycling, difficulty in breaking the wind, insufficient stability, and impacts on the user's riding efficiency and experience.

### SUMMARY

The present invention aims to provide a manufacturing method of a spoke assembly to solve the above-mentioned technical problems.

To achieve the above objective, the technical solution of the present invention is: The manufacturing method of a spoke assembly includes the following steps:
S1: providing a preform made of cylindrical carbon fiber;
S2: providing a first connector and a second connector, where the first connector and the second connector each have a conical through hole;
S3: enabling the first connector and the second connector to sleeve appropriate positions of a middle portion of the preform via the through holes, respectively;
S4: wrapping consecutive carbon fiber layers around two ends of the preform to form conical pillar sections;
S5: placing the preform into an end forming mold, and curing the conical pillar sections at two ends of the preform at one time to form fixed joints, where fibers in the inner and outer carbon fiber layers wrapped sequentially are distributed continuously along a taper of the fixed joints;
S6: applying pulling forces toward end sides to the first connector and the second connector, to force the first connector and the second connector to respectively sleeve the fixed joints at two ends of the preform;
S7: wrapping a continuous carbon fiber layer on the middle portion of the preform, and placing the entire preform into a main body forming mold for curing, such that the middle portion of the preform forms a main body and the preform is processed into a spoke; and
S8: applying the pulling forces toward the end sides to the first connector and the second connector again, to force the first connector and the second connector to sleeve the fixed joints more tightly, and ensuring an overall length of the spoke assembly is accurate, thereby forming a complete spoke assembly.

Preferably, in step S7, the main body forming mold cures the middle portion of the preform into a flat main body.

Preferably, the spoke includes cylindrical transition sections located between the main body and the fixed joints, where the cylindrical transition sections are exposed outside the first connector or the second connector, and lengths of the cylindrical transition sections are smaller than lengths of the first connector and the second connector, respectively.

Preferably, the spoke further includes inclined transition sections located between the main body and the cylindrical transition sections, where a width of the inclined transition section gradually decreases from the main body toward the cylindrical transition section, two ends of the inclined transition section are a rounded end face and a flat surface, respectively, the rounded end face correspondingly matches the cylindrical transition section, and the flat surface correspondingly matches the main body.

Preferably, of the spoke assembly, a direction toward a center of the spoke assembly is defined as an inner side, and a direction away from the center of the spoke assembly is defined as an outer side, where the through hole is a conical through hole gradually expanding from inside outward, the fixed joint is a conical fixed joint gradually expanding from inside outward, and the conical through hole and the conical fixed joint are correspondingly engaged in a limiting manner.

Preferably, the first connector is a nut cap connected to and cooperating with a rim, and the second connector is a cap head connected to and cooperating with a hub.

The present invention has the following beneficial effects:
(1) With the use of the end forming mold, the conical pillar sections at both ends of the preform are cured at one time to form fixed joints, which means that the inner layer of the fixed joint and the outer layer of the fixed joint of the spoke are heated and cured together, enabling the fibers in the inner and outer carbon fiber layers wrapped sequentially at the fixed joint to be continuously distributed along the taper of the fixed joint without disconnection. This makes the fixed joint less prone to delamination or slippage, making it safer and more reliable.
(2) It is unnecessary to reserve a long length for the cylindrical transition section at the end of the spoke, and correspondingly, the main body can be processed relatively longer, making the length of the main body account for a larger proportion of the overall length of the spoke. Moreover, since the main body is flat, the main body being longer indicates smaller wind resistance during cycling, making it easier to break the wind. Through experimental testing, the wind-breaking performance of the spoke assembly manufactured by the method of the present invention is improved by 20-30% compared with that of the spoke assembly manufactured by conventional methods, with good stability, enhancing the user's riding efficiency and experience.

### BRIEF DESCRIPTION OF DRAWINGS

FIG. 1 is a schematic diagram of appearance of a preform according to an embodiment of the present invention.

FIG. 2 is a schematic diagram of assembly of a spoke assembly according to an embodiment of the present invention.

FIG. 3 is an exploded schematic diagram of the spoke assembly according to an embodiment of the present invention.

FIG. 4 is a front view according to an embodiment of the present invention.

FIG. 5 is a cross-sectional view at A-A in FIG. 4.

FIG. 6 is a schematic structural diagram of a cap head according to an embodiment of the present invention.

FIG. 7 is a cross-sectional view of a fixed joint of a spoke after one-time molding according to an embodiment of the present invention.

FIG. 8 is a schematic diagram of appearance of a spoke in the prior art.

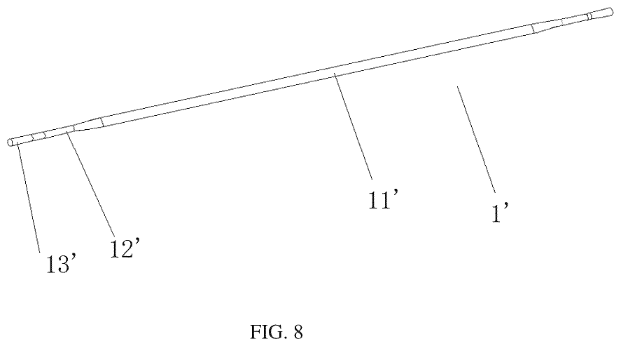

FIG. 9 is a cross-sectional view of a fixed joint of the spoke in the prior art after secondary molding.

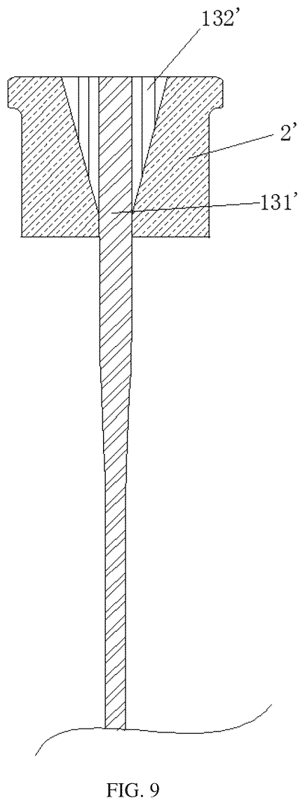

### REFERENCE NUMERALS IN THE FIGURE

In the prior art: 1′. spoke, 11′. main body, 12′. cylindrical transition section, 13′. fixed joint, 131′. inner layer of the fixed joint, 132′. outer layer of the fixed joint, and 2′. cap head.

In the present invention: 100. preform, 1. spoke, 11. main body, 12. inclined transition section, 121. rounded end face, 122. flat surface, 13. cylindrical transition section, 14. conical pillar section, 15. fixed joint, 2. first connector, 3. second connector, and 4. through hole.

### DESCRIPTION OF EMBODIMENTS

To further illustrate the embodiments, the present invention provides accompanying drawings. These drawings are part of the disclosure of the present invention, primarily used to illustrate the embodiments and, in conjunction with the relevant descriptions in the specification, to explain the operating principles of the embodiments. With reference to these contents, those of ordinary skill in the art should be able to understand other possible implementations and the advantages of the present invention. The components in the drawings are not drawn to scale, and similar component symbols are typically used to represent similar components.

In the description of the present invention, unless otherwise specified, the term “multiple” means two or more; the terms “upper,” “lower,” “left,” “right,” “inner,” “outer,” “front,” “rear,” “head,” “tail,” and the like indicating orientation or positional relationships are based on the orientation or positional relationships shown in the drawings, solely for the convenience of describing the present invention and simplifying the description, and do not indicate or imply that the referred device or element must have a specific orientation, be constructed or operated in a specific orientation, and thus cannot be construed as limiting the present invention. Furthermore, the terms “first,” “second,” “third,” and the like are used for descriptive purposes only and cannot be construed as indicating or implying relative importance.

In the description of the present invention, it should be noted that, unless otherwise expressly specified and limited, the terms “joining” and “connection” should be understood in a broad sense. For example, it may be a fixed connection, a detachable connection, or an integral connection; it may be a mechanical connection or an electrical connection; or it may be a direct connection or an indirect connection through an intermediate medium. For those of ordinary skill in the art, the specific meanings of the above terms in the present invention can be understood based on specific circumstances.

For convenience of description, of a spoke assembly, a direction toward a center of the spoke assembly is defined as an inner side, and a direction away from the center of the spoke assembly is defined as an outer side.

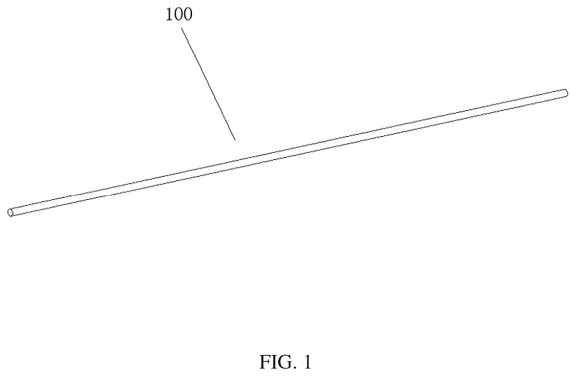

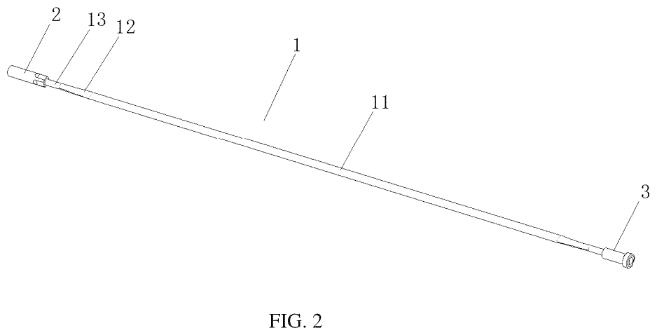

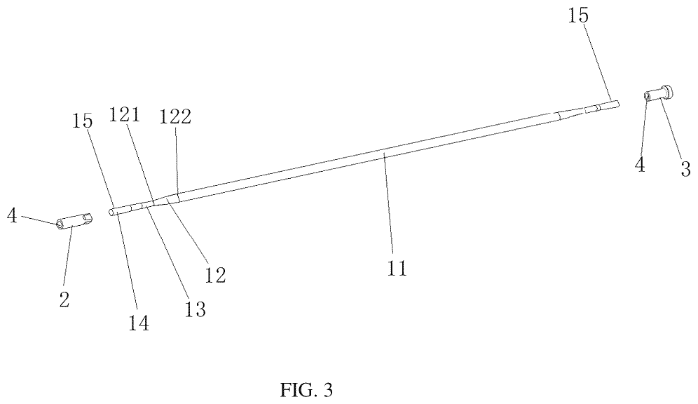

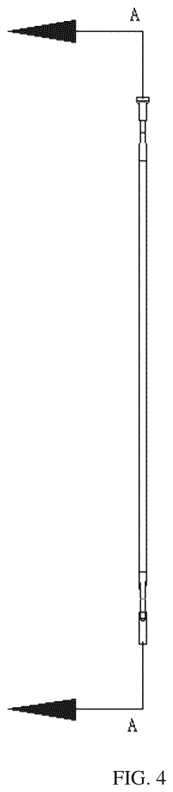

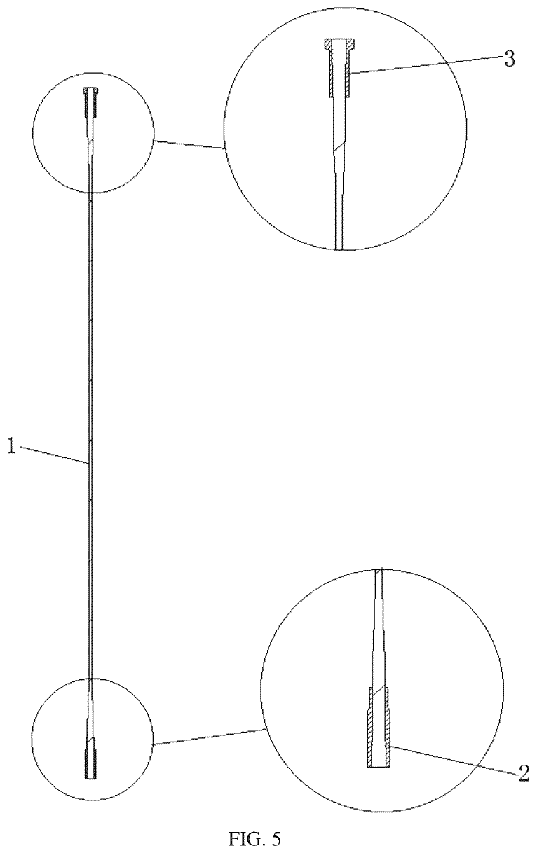

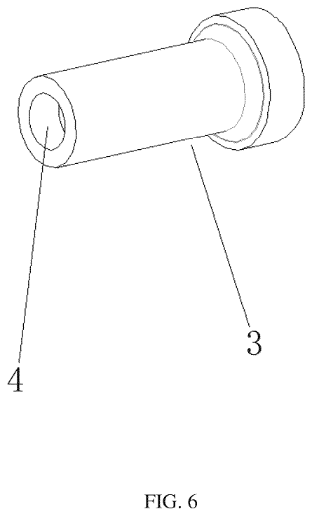

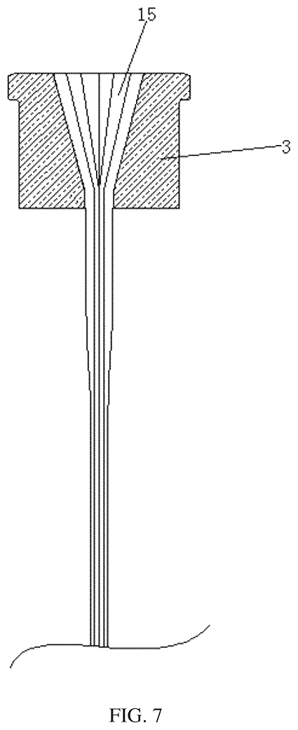

As shown in FIGS. 1 to 7, according to an embodiment of the present invention, a manufacturing method of a spoke assembly is provided, including the following steps:
S1: Provide a preform 100 made of cylindrical carbon fiber.
S2: Provide a first connector 2 and a second connector 3, where the first connector 2 and the second connector 3 each have a conical through hole 4.
S3: Enable the first connector 2 and the second connector 3 to sleeve appropriate positions of a middle portion of the preform 100 via the through holes 4, respectively.
S4: Wrap consecutive carbon fiber layers around two ends of the preform 100 to form conical pillar sections 14.
S5: Place the preform 100 into an end forming mold, and cure the conical pillar sections 14 at two ends of the preform 100 at one time to form fixed joints 15, where fibers in the inner and outer carbon fiber layers wrapped sequentially at the fixed joints 15 are distributed continuously along a taper of the fixed joints 15.
S6: Apply pulling forces toward end sides to the first connector 2 and the second connector 3, to force the first connector 2 and the second connector 3 to respectively sleeve the fixed joints 15 at two ends of the preform 100.
S7: Wrap a continuous carbon fiber layer on the middle portion of the preform 100, and place the entire spoke 1 into a main body forming mold for curing, such that the middle portion of the preform 100 forms a main body 11 and the preform 100 is processed into a spoke.
S8: Apply the pulling forces toward the end sides to the first connector 2 and the second connector 3 again, to force the first connector 2 and the second connector 3 to sleeve the fixed joints 15 more tightly, and ensure an overall length of the spoke assembly is accurate, thereby forming a complete spoke assembly.

In step S7, the main body forming mold cures the middle portion of the preform 100 into a flat main body.

The first connector 2 is a nut cap connected to and cooperating with a rim, and the second connector 3 is a cap head connected to and cooperating with a hub.

The spoke 1 includes cylindrical transition sections 13 located between the main body 11 and the fixed joints 15, where the cylindrical transition sections 13 are exposed outside the first connector 2 or the second connector 3, and lengths of the cylindrical transition sections 13 are smaller than lengths of the first connector 2 and the second connector 3, respectively.

The manufacturing method of a spoke assembly of the present invention has the following advantages:
(1) With the use of the end forming mold, the conical pillar sections 14 at both ends of the preform 100 are cured at one time to form fixed joints 15, which means that the inner layer of the fixed joint 15 and the outer layer of the fixed joint 15 of the spoke 1 are heated and cured together, enabling the fibers in the inner and outer carbon fiber layers wrapped sequentially at the fixed joint 15 to be continuously distributed along the taper of the fixed joint 15 without disconnection. This makes the fixed joint 15 less prone to delamination or slippage, making it safer and more reliable.
(2) The nut cap and the cap head can temporarily sleeve appropriate positions in the middle portion of the preform 100. After the two ends of the preform 100 are wrapped with consecutive carbon fiber layers to form the conical pillar sections 14 and heated and cured at one time to form the fixed joints 15, the nut cap and the cap head are pulled toward two ends, to respectively sleeve the fixed joints 15 at two ends of the preform 100. Then, a continuous carbon fiber layer is wrapped on the middle portion of the preform 100, and the entire preform 100 is placed into the main body forming mold for curing, such that the middle portion of the preform 100 is heated and cured at one time to form the flat main body 11, thereby processing the preform 100 into the spoke 1. The second pulling force toward one end side is applied to the nut cap or the cap head, forcing the nut cap or cap head to sleeve the fixed joint 15 more tightly, and it is ensured that the overall length of the spoke assembly is accurate, thus forming a complete spoke assembly. This method eliminates the need to reserve a long length for the cylindrical transition section 13 at the end of the spoke 1, and correspondingly, the main body 11 can be processed relatively longer, making the length of the main body 11 account for a larger proportion of the overall length of the spoke 1. Moreover, since the main body 11 is flat, the main body 11 being longer indicates smaller wind resistance during cycling, making it easier to break the wind. Through experimental testing, the wind-breaking performance of the spoke assembly manufactured by the method of the present invention is improved by 20-30% compared with that of the spoke assembly manufactured by conventional methods, with good stability, enhancing the user's riding efficiency and experience.

Certainly, in other cases, the main body may alternatively be processed into shapes other than flat, such as cylindrical or diamond-shaped.

In this embodiment, of the spoke assembly, the direction toward the center of the spoke assembly is defined as the inner side, and the direction away from the center of the spoke assembly is defined as the outer side. The through hole 4 is a conical through hole gradually expanding from inside outward, and the fixed joint 15 is a conical fixed joint gradually expanding from inside outward. The conical through hole and the conical fixed joint are correspondingly engaged in a limiting manner, thereby enabling the nut cap and the cap head to respectively fixedly sleeve the fixed joints 15 at the ends of the spoke 1. Since the rim and the hub respectively exert outward pulling forces on the nut cap and the cap head, the conical structure of the conical through hole and conical fixed joint makes the force on the nut cap and the cap head more stable and the installation more secure.

In this embodiment, the spoke 1 further includes an inclined transition section 12 located between the main body 11 and the cylindrical transition section 13. The width of the inclined transition section 12 gradually decreases from the main body 11 toward the cylindrical transition section 13. Two ends of the inclined transition section 12 are a rounded end face 121 and a flat surface 122, respectively. The rounded end face 121 correspondingly matches the cylindrical transition section 13, and the flat surface 122 correspondingly matches the main body 11, ensuring a smoother and more stable transition between the main body 11 and the cylindrical transition section 13.

Although the present invention has been specifically shown and described with reference to preferred implementations, those skilled in the art should understand that various changes in form and detail made to the present invention, within the spirit and scope of the present invention as defined by the appended claims, fall within the protection scope of the present invention.

1. A manufacturing method of a spoke assembly, comprising the following steps:
S1: providing a preform made of cylindrical carbon fiber;
S2: providing a first connector and a second connector, wherein the first connector and the second connector each have a conical through hole;
S3: enabling the first connector and the second connector to sleeve appropriate positions of a middle portion of the preform via the conical through holes, respectively;
S4: wrapping consecutive carbon fiber layers around two ends of the preform to form conical pillar sections;
S5: placing the preform into an end forming mold, and curing the conical pillar sections at the two ends of the preform at one time to form fixed joints, wherein fibers in an inner carbon fiber layer and an outer carbon fiber layer of the consecutive carbon fiber layers wrapped sequentially are distributed continuously along a taper of the fixed joints;
S6: applying pulling forces toward end sides to the first connector and the second connector, to force the first connector and the second connector to respectively sleeve the fixed joints at the two ends of the preform;
S7: wrapping a continuous carbon fiber layer on the middle portion of the preform, and placing an entirety of the preform into a main body forming mold for curing, such that the middle portion of the preform forms a main body and the preform is processed into a spoke; and
S8: applying the pulling forces toward the end sides to the first connector and the second connector again, to force the first connector and the second connector to sleeve the fixed joints more tightly than in the step S6, and ensuring an overall length of the spoke assembly meets a specified length, thereby forming a complete spoke assembly.

2. The manufacturing method of a spoke assembly according to claim 1, wherein in the step S7, the main body forming mold cures the middle portion of the preform into a flat main body.

3. The manufacturing method of a spoke assembly according to claim 1, wherein the spoke comprises cylindrical transition sections located between the main body and the fixed joints, wherein the cylindrical transition sections are exposed outside the first connector or the second connector, and lengths of the cylindrical transition sections are smaller than lengths of the first connector and the second connector, respectively.

4. The manufacturing method of a spoke assembly according to claim 3, wherein the spoke further comprises inclined transition sections located between the main body and the cylindrical transition sections, wherein a width of each of the inclined transition sections gradually decreases from the main body toward a corresponding one of the cylindrical transition sections, two ends of each of the inclined transition sections are a rounded end face and a flat surface, respectively, the rounded end face correspondingly matches the corresponding one of the cylindrical transition sections, and the flat surface correspondingly matches the main body.

5. The manufacturing method of a spoke assembly according to claim 1, wherein, with respect to the spoke assembly, a direction toward a center of the spoke assembly is defined as an inner side, and a direction away from the center of the spoke assembly is defined as an outer side, wherein the conical through holes gradually expand from inside outward, the fixed joints are conical fixed joints gradually expanding from inside outward, and the conical through holes and the conical fixed joints are correspondingly engaged in a limiting manner.

6. The manufacturing method of a spoke assembly according to claim 1, wherein the first connector is a nut cap connected to and cooperating with a rim, and the second connector is a cap head connected to and cooperating with a hub.
